(19) United States
(12) Patent Application Publication
(10) Pub. No.: US 2021/0212163 A1
(43) Pub. Date: Jul. 8, 2021

(54) RELAY APPARATUS, COMMUNICATION SYSTEM, RELAY METHOD, AND NON-TRANSITORY COMPUTER READABLE MEDIUM STORING RELAY PROGRAM

(71) Applicant: NEC CORPORATION, Tokyo (JP)

(72) Inventor: Tsukasa KOBAYASHI, Tokyo (JP)

(73) Assignee: NEC CORPORATION, Tokyo (JP)

(21) Appl. No.: 16/087,331

(22) PCT Filed: Jan. 11, 2017
(86) PCT No.: PCT/JP2017/000548

§ 371 Date: Sep. 21, 2018

(30) Foreign Application Priority Data
Mar. 22, 2016 (JP) 2016-056895

(51) Int. Cl. H04W 88/04; H04L 12/66; H04W 88/16; H04B 7/155

(52) U.S. Cl. CPC H04W 88/04; H04B 7/15507; H04W 88/16; H04L 12/66

(57) ABSTRACT

A gateway (110) includes: a communication interface (111) capable of communicating with a communication apparatus (201); a communication interface (112) capable of communicating with a communication apparatus (202); an application execution unit (113) configured to execute an application (AP_0) connected to the communication apparatus (201) via a communication path (PT_1) and connected to the communication apparatus (202) via a communication path (PT_2); and a switch unit (114) configured to associate the communication apparatus (201) with the relay application (AP_0) and associate the communication apparatus (202) with the application (AP_0), thereby switching a packet to be input/output between the communication interfaces (111) and (112) and the application (AP_0).

### TECHNICAL FIELD

The present disclosure relates to a relay apparatus, a communication system, a relay method, and a relay program, and more particularly, to a relay apparatus, a communication system, a relay method, and a relay program for executing an application.

### BACKGROUND ART

In recent years, various types of networks have been used and how to ensure security in these networks is a serious problem. One known method of ensuring security in a situation in which a plurality of types of systems or users having authorities different from one another are mixed in one physical network is a method of logically separating access paths. One exemplary logical separation method includes, for example, OpenFlow technology defined by Software Defined Network (SDN) (see, for example, Non-Patent Literature 1).

On the other hand, Internet of Things (IoT), which enables various kinds of objects to be connected to the Internet, has been focused. IoT allows devices such as sensors or smart meters to be connected to the Internet, whereby it becomes possible to collect sensor data and measured data on the cloud (server) to perform automatic recognition, automatic control, remote measurement and the like.

The studies of edge computing have been conducted as one of techniques for achieving IoT (see Non-Patent Literature 2 as an example of mobile edge computing). The edge computing is a technology in which a part of computing (distribution processing) is performed at an edge (gateway) on the side of an on-site device instead of transmitting all the pieces of data of the device to the cloud and analyzing and processing all these pieces of data on the cloud. Edge computing has made it possible to prevent the amount of data to be sent to the cloud from being large and the response from being deteriorated even in a case in which the amount of data from the device has increased. In edge computing, it is required to cause the gateway to have a computing function by an application or the like.

When, for example, images are constantly sent to the cloud from a camera device, if WAN is a cellular network, the communication charge becomes enormous and a response from the cloud is deteriorated. By monitoring images in the gateway once, cutting only data where there is a change from a previous image, and sending this data to the server by edge computing, it is possible to reduce the amount of charge (the amount of data) and to improve the response.

In addition, Patent Literature 1 and 2 are known as related techniques.

### CITATION LIST

### Patent Literature

[Patent Literature 1] Japanese Unexamined Patent Application Publication No. 2012-085005
[Patent Literature 2] Japanese Unexamined Patent Application Publication No. 2003-167805

### Non-Patent Literature

[Non-Patent Literature 1] ONF (Open Network Foundation), “OpenFlow Switch Specification”, Version 1.3.4, Mar. 27, 2014
[Non-Patent Literature 2] ETSI GS MEC-IEG 004, “Mobile-Edge Computing (MEC); Service Scenarios”, V1.1.1, November, 2015

### SUMMARY OF INVENTION

### Technical Problem

However, in the relay apparatus including the application such as edge computing, there is a problem that it is difficult to ensure security since a method of logically separating the communication paths has not been taken into account.

The present disclosure has been made in view of the aforementioned problem and aims to provide a relay apparatus, a communication system, a relay method, and a relay program capable of improving security.

### Solution to Problem

A relay apparatus according to the present disclosure includes: a first communication interface capable of communicating with a first communication apparatus; a second communication interface capable of communicating with a second communication apparatus; an application execution unit for executing a relay application, the relay application being connected to the first communication apparatus via a first communication path and connected to the second communication apparatus via a second communication path; and a switch unit for associating the first communication apparatus with the relay application and associating the second communication apparatus with the relay application, thereby switching a packet to be input/output between the first and second communication interfaces and the relay application.

A communication system according to the present disclosure includes: a communication system including a first communication apparatus, a second communication apparatus, and a relay apparatus connected between the first and second communication apparatuses, in which the relay apparatus includes: a first communication interface capable of communicating with the first communication apparatus; a second communication interface capable of communicating with the second communication apparatus; an application execution unit for executing a relay application, the relay application being connected to the first communication apparatus via a first communication path and connected to the second communication apparatus via a second communication path; a switch unit for associating the first communication apparatus with the relay application and associating the second communication apparatus with the relay application, thereby switching a packet to be input/output between the first and second communication interfaces and the relay application.

A relay method according to the present disclosure is a relay method in a relay apparatus including a first communication interface capable of communicating with a first communication apparatus and a second communication interface capable of communicating with a second communication apparatus, the method including: executing a relay application, the relay application being connected to the first communication apparatus via a first communication path and connected to the second communication apparatus via a second communication path; and associating the first communication apparatus with the relay application and associating the second communication apparatus with the relay application, thereby switching a packet to be input/output between the first and second communication interfaces and the relay application.

A relay program according to the present disclosure is a relay program for causing a relay apparatus including a first communication interface capable of communicating with a first communication apparatus and a second communication interface capable of communicating with a second communication apparatus to execute the following processing of: executing a relay application, the relay application being connected to the first communication apparatus via a first communication path and connected to the second communication apparatus via a second communication path; and associating the first communication apparatus with the relay application and associating the second communication apparatus with the relay application, thereby switching a packet to be input/output between the first and second communication interfaces and the relay application.

### Advantageous Effects of Invention

According to the present disclosure, it is possible to provide a relay apparatus, a communication system, a relay method, and a relay program capable of improving security.

### BRIEF DESCRIPTION OF DRAWINGS

FIG. 1 is a configuration diagram showing a configuration of a communication system according to a reference example;

FIG. 2 is a diagram showing an image of separating communication paths in a communication system according to an embodiment;

FIG. 3 is a diagram showing a configuration example of an application in the communication system according to the embodiment;

FIG. 4 is a configuration diagram showing an overall configuration of a gateway according to the embodiment;

FIG. 5 is a configuration diagram showing a configuration of a gateway according to a first embodiment;

FIG. 6 is a configuration diagram showing a specific example of a communication system according to the first embodiment;

FIG. 7 is a diagram showing a specific example of a white list table according to the first embodiment;

FIG. 8 is a flowchart showing an operation example of the gateway according to the first embodiment;

FIG. 9 is a flowchart showing an operation example of the gateway according to the first embodiment;

FIG. 10 is a diagram for describing effects of the gateway according to the first embodiment;

FIG. 11 is a configuration diagram showing an example of NAPT communication according to a reference example;

FIG. 12 is a diagram showing an image of separating communication paths in a communication system according to a second embodiment;

FIG. 13 is a configuration diagram showing a specific example of the communication system according to the second embodiment;

FIG. 14 is a diagram showing a specific example of a white list table according to the second embodiment;

FIG. 15 is a flowchart showing an operation example of a gateway according to the second embodiment; and

FIG. 16 is a flowchart showing an operation example of the gateway according to the second embodiment.

### DESCRIPTION OF EMBODIMENTS

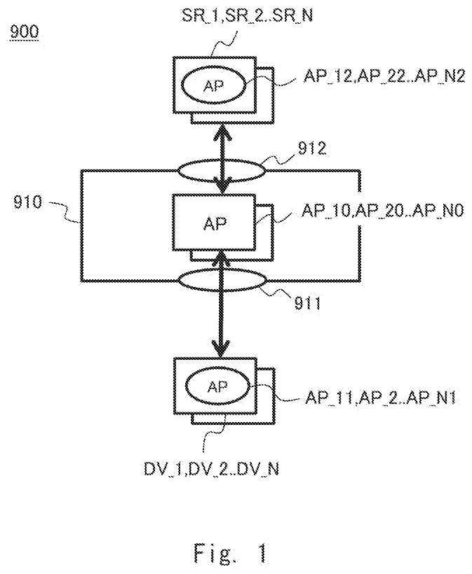

(Outline of embodiments) As described above, in recent years, starting with IoT, the number of system configurations in which data of sensor devices on the site are collected on the cloud (server) via a gateway has been increasing. FIG. 1 shows a configuration of a communication system according to a reference example in which the edge computing of IoT is applied to a gateway.

As shown in FIG. 1, a communication system 900 according to a reference example includes a plurality of devices DV (DV_1-DV_N), a plurality of servers SR (SR_1-SR_N), and a gateway 910 that relays communication between the plurality of devices DV and the plurality of servers SR. The devices DV_1-DV_N respectively execute applications AP_11-AP_N1 and the servers SR_1-SR_N respectively execute applications AP_12-AP_N2. For example, each of the applications AP_12-AP_N2 is a server application (a video distribution server, a Web server etc.) and each of the applications AP_11-AP_N1 is a client application (a video playback software, a Web browser etc.) for the server.

The gateway 910 according to the reference example is connected to the devices DV_1-DV_N via a communication interface 911, connected to the servers SR_1-SR_N via a communication interface 912, and executes applications AP_10-AP_N0.

Each of the applications AP_10-AP_N0 of the gateway 910 is an application (image conversion software, data primary analysis/processing software, data compression/quantization software etc.) for performing edge computing and is connected between the applications AP_11-AP_N1 of the device DV and the applications AP_12-AP_N2 of the server SR.

In the reference example as shown in FIG. 1, however, it is impossible to logically separate a path into a plurality of access paths in accordance with the type of the system in the physical network. Therefore, communications of a plurality of systems use one path, which raises security concern.

Further, when a relay apparatus that corresponds to the gateway is focused, there are techniques for constructing an application closed space in which communications of the systems do not have any influence on one another by virtualization such as a container technology (e.g., Docker) or VMware. However, there is a problem that, in a low cost/low resource relay apparatus that is installed on site such as IoT (e.g., a communication device that uses an ARM processor), such a complicated technology cannot be applied in view of performance and resources.

The following embodiments aim to logically separate, when a plurality of systems (communications, applications) are mounted on the gateway formed of a low cost/low resource device, the communication paths of the respective systems and to improve security.

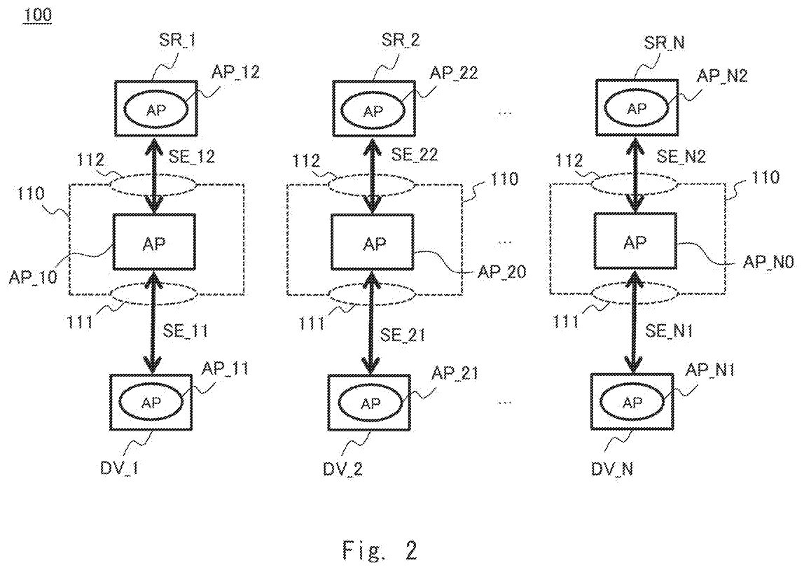

FIG. 2 shows an image in which communication paths are logically separated from each other in the communication system according to the embodiment. As shown in FIG. 2, in a gateway 110 (a plurality of gateways 110 are virtually shown) in a communication system 100 according to the embodiment, applications AP_10-AP_N0 are respectively connected to applications AP_11-AP_N1 of a device DV via sessions SE_11-SE_N1 and are respectively connected to applications AP_12-AP_N2 of a server SR via sessions SE_12-SE_N2. Two communications, that is, the communication (sessions SE_11-SE_N1) between the device DV on the LAN side and the applications AP_10-AP_N0 in the gateway 110 and the communication (sessions SE_12-SE_N2) between the applications AP_10-AP_N0 in the gateway 110 and the server SR on the WAN side are associated with each other and the communication paths are logically separated from each other.

In this embodiment, even in a case in which the access paths are logically separated from each other among the device DV, the gateway 110, and the server SR and a low resource device is used while the communication control has been focused, the security level can be improved.

As shown in FIG. 2, the devices DV_1-DV_N do not directly (via the gateway) communicate with the servers SR_1-SRN_N and the devices DV_1-DV_N communicate with the applications AP_10-AP_N0. The applications AP_10-AP_N0 process or thin out data received from the devices DV_1-DV_N via the sessions SE_11-SE_N1 and then transmit only the data that is required to be transmitted to the servers SR_1-SR_N on the cloud via the sessions SE_12-SE_N2. The feature of the embodiment is to associate the first communication (sessions SE_11-SE_N1) with the second communication (sessions SE_12-SE_N2) in the applications AP_10-AP_N0 of the gateway 110.

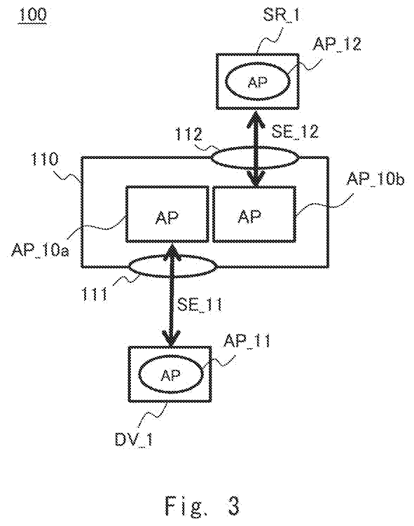

While the example in which one application of the gateway communicates with both the device and the server is described in this embodiment, as shown in FIG. 3, similar functions may be achieved by a plurality of applications. For example, the gateway 110 may include an application AP_10a that processes data received from the device DV_1 via the session SE_11 and an application AP_10b that transmits data that has been processed to the server SR_1 via the session SE_12. In this case, the session SE_11 is associated with the application AP_10a and the session SE_12 is associated with the application AP_10b.

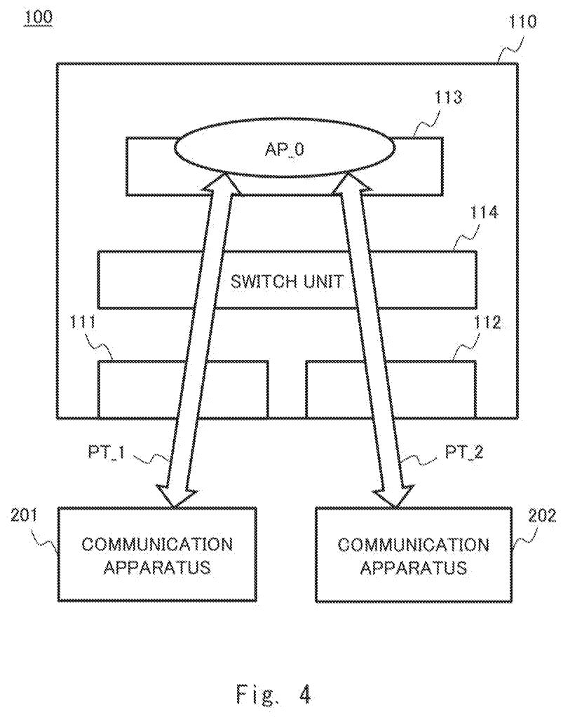

FIG. 4 shows an overall configuration of the communication system including the relay apparatus according to this embodiment. As shown in FIG. 4, the gateway (relay apparatus) 110 included in the communication system 100 according to this embodiment includes communication interfaces 111 and 112, an application execution unit 113, and a switch unit 114.

The communication interface 111 can communicate with a communication apparatus 201 (device etc.) and the communication interface 112 can communicate with a communication apparatus 202 (server etc.). The application execution unit 113 is connected to the communication apparatus 201 via a communication path PT_1 and executes an application (relay application) AP_0 that is connected to the communication apparatus 202 via a communication path PT_2. The switch unit 114 associates the communication apparatus 201 with the application AP_0 and associates the communication apparatus 202 with the application AP_0, thereby switching the packet input/output between the communication interfaces 111 and 112 and the application AP_0. According to this configuration, the communication paths can be logically separated from each other and security can be easily improved.

### First Embodiment

Hereinafter, with reference to the drawings, a first embodiment will be explained. In this embodiment, a switch for controlling communication is mounted on a gateway, and control is performed based on a white list in which the association of the communication between the gateway and the device with the communication between the gateway and the server is configured in advance. Regarding the gateway, in particular, communication control of the association on a basis of a communication application mounted on the gateway is performed. While the gateway will be explained here as an example of the relay apparatus, the relay apparatus may instead be, for example, a router or a switch apparatus.

### <Configuration of Gateway>

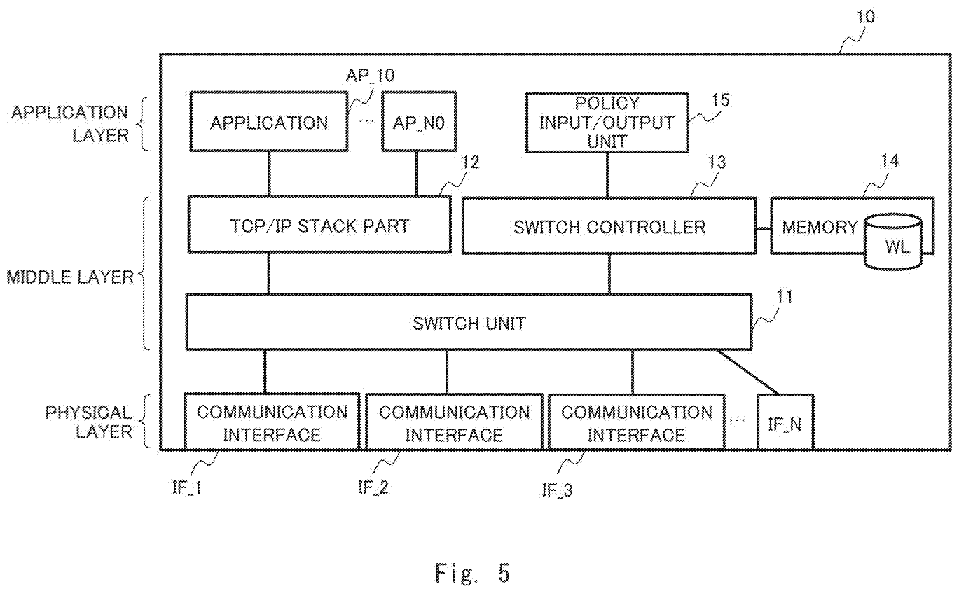

FIG. 5 shows a configuration of the gateway according to this embodiment. As shown in FIG. 5, a gateway 10 according to this embodiment includes a plurality of communication interfaces IF (IF_1-IF_N), a switch unit 11, a TCP/IP stack part 12, a switch controller 13, a memory 14, a plurality of applications AP (AP_10-AP_N0), and a policy input/output unit 15. In a function hierarchical example, the communication interfaces IF_1-IF_N correspond to a physical layer, the switch unit 11, the TCP/IP stack part 12, the switch controller 13, and the memory 14 correspond to a middle layer, and the applications AP_10-AP_N0 and the policy input/output unit 15 correspond to an application layer. FIG. 5 is one example of the functional block of the gateway and the gateway may have another configuration as long as it can perform the operation according to this embodiment. For example, the switch unit may include the switch unit 11 and the switch controller 13 or the TCP/IP stack part 12 may be included in the application AP or the switch unit 11.

Each of the communication interfaces IF_1-IF_N is a physical interface that is connected to a communication apparatus such as a device or a server via a network of a predetermined communication standard. For example, the communication interface IF_1 conforms to WiFi (registered trademark) standards and is connected to the LAN of WiFi. The communication interface IF_2 conforms to LTE (one example of the cellular) standards and is connected to the WAN of LTE. The communication interface IF_3 conforms to Ethernet (registered trademark) standards and is connected to the LAN or WAN of Ethernet. WiFi, LTE, and Ethernet to be applied to the communication interfaces are merely examples of wired/wireless connection and are not limited thereto. They may be other types of wired/wireless connection such as USB or Bluetooth (registered trademark).

The switch unit 11 switches the forwarding destination of the packet to be input/output based on the control (configuration) from the switch controller 13. The switch unit 11 outputs, when it outputs the packet from the gateway 10 to each network, the packet in the path based on pre-configured flow rules (forward rules) via the communication interfaces IF_1-IF_N associated with the switch. When the packet is input from each network to the gateway 10, the switch unit 11 forwards the packet to the applications AP_10-AP_N0 in the gateway (via the TCP/IP stack) based on the pre-configured flow rules. For example, the switch unit 11 is an open flow (SDN) switch (Open vSwitch) that is used in the open flow, but is not limited thereto.

The switch unit 11 includes, for example, a flow rule storing unit (not shown) that stores the flow rules. The flow rules of the switch unit 11 are processing rules applied to the packet to be input, and conditions of the packet and the processing content are configured therein. A transmission source address, a transmission source port number, a destination address, a destination port number, an input communication interface, an output communication interface, an input application, an output application and the like are configured as the conditions of the packet of the flow rules, and an output communication interface, packet forwarding to the output application or packet discard, change of the address and the port number etc. are configured as the processing content of the flow rules.

The memory 14 is a storing unit (table storing unit) that stores a white list table WL and the like for defining the flow rules of the switch unit 11. Conditions of the packet that permits the communication are described in the white list table WL, which is set, for example, by the user in advance. The switch controller 13 may generate the white list table WL based on the policy. The memory 14 may store other information that is necessary for the processing of the switch controller 13. The policy input/output unit 15 is an input/output part to externally inputting the policy for defining the flow rules of the switch unit 11 (and the white list table WL). The policy input/output unit 15 may be, for example, a user interface such as GUI and the user may input the policy via the GUI.

The switch controller 13 configures the flow rules in the switch unit 11 based on the policy to be input and the white list table WL that has been stored. The switch controller 13 is, for example, an open flow (SDN) controller used in the open flow. Upon receiving the packet, the switch unit 11 processes the packet in accordance with the flow rules when the flow rules to be applied to the packet have been configured. On the other hand, when the flow rules to be applied to the packet have not been configured, the switch unit 11 sends an inquiry about the rules to the switch controller 13. Then the switch controller 13 configures the flow rules in the switch unit 11 in accordance with the policy and the white list table WL.

The TCP/IP stack part 12 is a packet processor that processes the packet in accordance with the TCP/IP protocol. The TCP/IP protocol is merely one example of the protocol of a transport layer/network layer and another protocol such as UDP/IP may instead be used. For example, the communication path that connects the application layers end-to-end in accordance with the TCP/IP protocol is a session.

The applications AP_10-AP_N0 are applications (programs) executed in the gateway in order to perform edge computing (processing related to the functions of the server and the device). The applications AP_10-AP_N0 are connected to the device or the server via the communication interfaces IF_1-IF_N and communicate with them. For example, similar to the aforementioned processing, the applications AP_10-AP_N0 process or thin out data received from the device, and then transmit only the necessary data to the server. The applications AP_10-AP_N0 may process image data received from a camera device, and transmit feature data including only feature points of the image to the server, where matching processing and the like may be performed based on this feature data.

### <Specific Example of System>

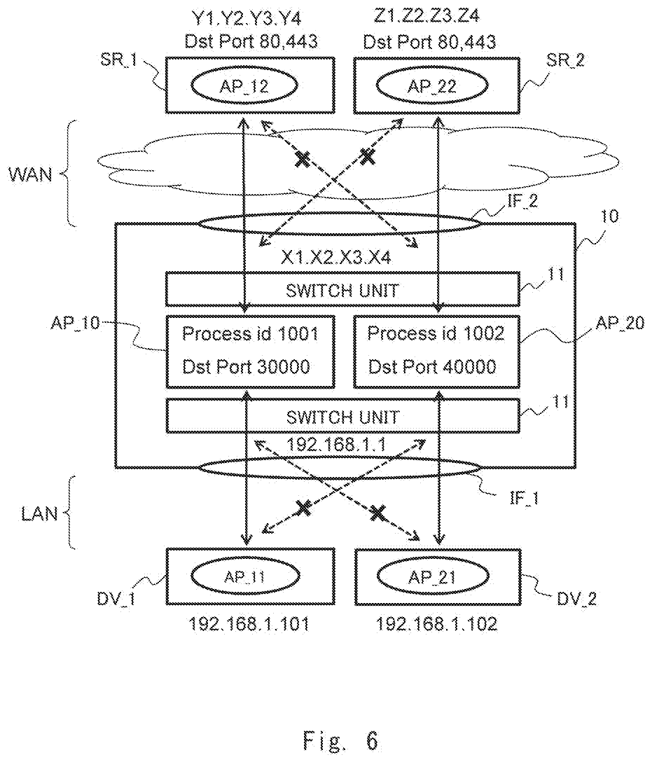

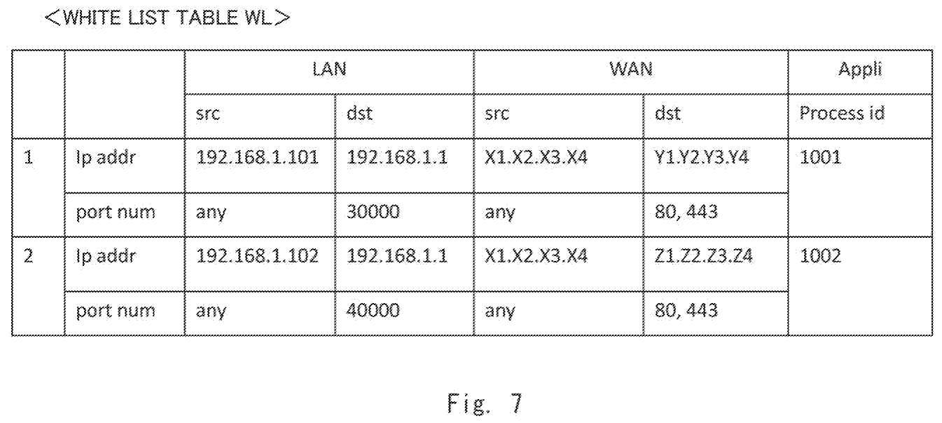

FIG. 6 shows a specific example of the system including the gateway according to this embodiment and FIG. 7 shows a specific example of the white list table used in this system. While two switch units 11 are respectively drawn on the LAN side and on the WAN side in FIG. 6 in order to facilitate understanding, in reality, the system is implemented by just one physical switch unit 11, as shown in FIG. 5.

As shown in FIG. 6, in this example, the gateway 10 includes a communication interface IF_1 for WiFi on the LAN side and a communication interface IF_2 for LTE on the WAN side, and relays the communication between the WiFi network on the LAN side and the LTE network on the WAN side. The communication interface IF_1 on the LAN side is connected to the two devices DV_1 and DV_2 via the WiFi network and the communication interface IF_2 on the WAN side is connected to the two servers SR_1 and SR_2 via the LTE network (cloud).

Two applications AP_10 and AP_20 that perform socket communication are mounted on the gateway 10 and these applications are executed in the gateway 10. The communication with the device DV_1 is performed by the application AP_10 and the communication with the device DV_2 is performed by the application AP_20. For example, the application AP_10 connects the session with the application AP_11 (client application) executed in the device DV_1 and communicates with the application AP_11, and the application AP_20 connects the session with the application AP_21 executed in the device DV_2 and communicates with the application AP_21. The application AP_10 and the application AP_11, and the application AP_20 and the application AP_21 are each terminated at a session.

Further, the applications AP_10 and AP_20 respectively communicate with the servers SR_1 and SR_2 (cloud) that coincide with the use of respective applications (applications of the devices). The communication with the server SR_1 is performed by the application AP_10 and the communication with the server SR_2 is performed by the application AP_20. For example, the application AP_10 connects the session with the application AP_12 of the server SR_1 (server application) and communicates with the application AP_12 and the application AP_20 connects the session with the application AP_22 of the server SR_2 and communicates with the application AP_22. The application AP_10 and the application AP_12, and the application AP_20 and the application AP_22 are each terminated at a session.

As one example, after temperature and humidity data is transmitted from the device DV_1 (application AP_11), which is a temperature and humidity sensor, to the application AP_10, the application AP_10 that has received the temperature and humidity data sends this temperature and humidity data to the server SR_1 (application AP_12) without processing or after processing this data. In this case, the packet is sent from the IP address 192.168.1.101 of the device DV_1 to the IP address 192.168.1.1 and the port number 30000 of the communication interface IF_1. After the processing by the application AP_10 of the process id1001, the packet is sent from the IP address Z1.X2.X3.X4 of the communication interface IF_2 to the IP address Y1.Y2.Y3.Y4 and the port number 80 (port for HTTP) or 443 (port for HTTPS) of the server SR_1.

As another example, after waveform data output from the device DV_2 (application AP_21), which is a vibration sensor, is transmitted to the application AP_20 for waveform data processing, in a way similar to that described above, the application AP_20 sends this waveform data to the server SR_2 (application AP_22) without processing or after processing this waveform data. In this case, the packet is sent from the IP address 192.168.1.102 of the device DV_2 to the IP address 192.168.1.1 and the port number 40000 of the communication interface IF_1. After the processing of the application AP_20 of the process id1002, the packet is sent from the IP address Z1.X2.X3.X4 of the communication interface IF_2 to the IP address Z1.Z2.Z3.Z4 and the port number 80 or 443 of the server SR_2.

In this embodiment, the series of communication processing is easily (simply) achieved using this switch. Specifically, the communication between the device and the application mounted on the gateway and the communication between the application mounted on the gateway and the server (cloud) are controlled using the white list table WL. The white list able WL shown in FIG. 7 is an example of achieving the path shown in FIG. 6.

As shown in FIG. 7, the transmission source address (src Ip addr), the transmission source port number (src port num), the destination address (dst Ip addr), and the destination port number (dst port num) on the LAN side, the transmission source address (src Ip addr), the transmission source port number (src port num), the destination address (dst Ip addr), and the destination port number (dst port num) on the WAN side, and the process id of the application are associated with one another in the white list table WL. That is, as the information for permitting (associating) the packet between the LAN (device) and the application, the transmission source information and the destination information on the LAN side and the application identification information are associated with each other. As the information for permitting (associating) the packet between the application and the WAN (server), the transmission source information and the destination information on the WAN side and the application identification information are associated with each other.

In this example, in accordance with the path shown in FIG. 6, the transmission source address 192.168.1.101, the transmission source port number any, the destination address 192.168.1.1, and the destination port number 30000 permitted on the LAN side, the transmission source address X1.X2.X3.X4, the transmission source port number any, the destination address Y1.Y2.Y3.Y4, and the destination port number 80 or 443 permitted on the WAN side, and the process id1001 of the application are associated with one another.

Further, the transmission source address 19.168.1.102, the transmission source port number any, the destination address 192.168.1.1, and the destination port number 40000 permitted on the LAN side and the transmission source address X1.X2.X3.X4, the transmission source port number any, the destination address Z1.Z2.Z3.Z4, and the destination port number 80 or 443 permitted on the WAN side, and the process id1002 of the application are associated with one another.

The port number any indicates that all the port numbers are permitted. While the process id is shown as an example of the identification information of the application, an execution file name with a full path (e.g., /user/local/bin/xxx) may instead be designated or may be designated additionally. The application may perform control in view of not only the communication packet but also information (the id of the user that has activated the application) that can be determined from the OS.

While the IP address and the port number of the TCP/IP are specified as the transmission source information and the destination information in this example, the MAC address, the physical port number (communication interface number), the VLAN_ID or the like may instead be specified or may be specified additionally. While the information on the packet to be permitted is explicitly specified as the white list, only a black list in which information on a packet not to be permitted is set or a combination of the white list and the black list may instead be specified. Further, while the IP address and the port number are independently specified in this example, respective ranges of the IP address and the port number may be specified (e.g., IP addr: 192.168.1.1-192.168.1.10, port num: 30000-30200) or header field information other than IP addr or port num may be used. They are not limited to the examples shown in this embodiment.

### <Communication Control Between Device and Application Mounted on Gateway>

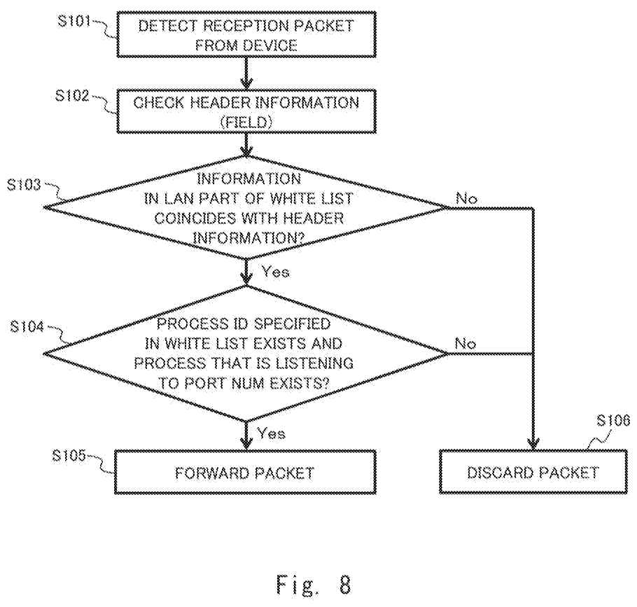

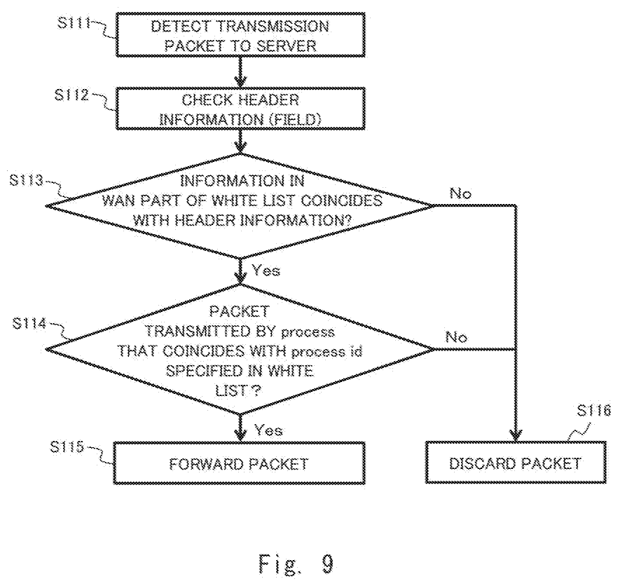

FIG. 8 is a control flow of the communication between the device and the application mounted on the gateway. While the control is described as being the control mainly executed by the switch unit 11, this control may be executed by the switch unit 11 and the switch controller 13 (the same is applicable to FIG. 9 described later).

As shown in FIG. 8, when the switch unit 11 mounted on the gateway 10 detects reception of the packet from the device DV (S101), the switch unit 11 checks the header field of the reception packet (S102). Specifically, in order to determine whether the header information coincides with the information in the white list table WL, the switch unit 11 acquires the transmission source address (src address), the transmission source port number (src port num), the destination address (dst address), and the destination port number (dst port num) from the header field of the packet.

Next, the switch unit 11 checks whether there is information in the LAN part of the white list table WL that coincides with the header information of the reception packet (S103). Specifically, the switch unit 11 determines whether the transmission source address, the transmission source port number, the destination address, and the destination port number of the reception packet coincide with the transmission source address, the transmission source port number, the destination address, and the destination port number on the LAN side of the white list table WL.

In the example shown in FIG. 7, when the header information of the reception packet is the transmission source address 192.168.1.101, the destination address 192.168.1.1 and the destination port number 30000, or the transmission source address 192.168.1.102, the destination address 192.168.1.1 and the destination port number 40000, it is determined that the header information coincides with the information in the white list table WL. Otherwise it is determined that the header information does not coincide with the information in the white list table WL.

When it is determined in S103 that there is information in the LAN part of the white list table WL that coincides with the header information, the switch unit 11 checks whether there is a process of the process id specified in the white list table WL and whether there is a process that is listening to the destination port number of the reception packet (S104). That is, the switch unit 11 checks the flow information (session information) and the socket information in the OS and compares them, thereby determining whether the process id of the process that is listening (LISTEN Port) at the destination port (dst port) coincides with the process id specified in the white list table WL (LAN).

In the example shown in FIG. 7, when the transmission source address is 192.168.1.101, the destination address is 192.168.1.1, and the destination port number is 30000, if the process of the corresponding process id1001 is being executed and this process is opening the port of the port number 30000, it is determined that there is a corresponding process. When the transmission source address is 192.168.1.102, the destination address is 192.168.1.1, and the destination port number is 40000, if the process of the corresponding process id1002 is being executed and this process is opening the port whose port number is 40000, it is determined that there is a corresponding process. Otherwise, it is determined that there is no corresponding process.

For example, by acquiring the list of the process ids and execution file names (and user names) by a ps command of Linux (registered trademark) and specifying the port number by an lsof command, the process id that is opening this port may be acquired.

When it is determined in S104 that there is a corresponding process, the switch unit 11 forwards the reception packet (S105). That is, the switch unit 11 forwards the packet to the destination that has been specified (des address, dst port num), as a result of which the packet is forwarded to the application in the gateway. In the example shown in FIG. 7, when the destination port number is 30000, the switch unit 11 forwards the packet to the process of the process id1001, and when the destination port number is 40000, the switch unit 11 forwards the packet to the process of the process id1002.

When it is determined in S103 that there is no information in the LAN part of the white list table WL that coincides with the header information or it is determined in S104 that there is no corresponding process, the switch unit 11 discards the reception packet (S106).

### <Communication Control Between Application Mounted on Gateway and Server (Cloud)>

FIG. 9 is a control flow of the communication between the application mounted on the gateway and the server (cloud).

As shown in FIG. 9, when the switch unit 11 mounted on the gateway 10 detects transmission of the packet from the application AP in the gateway (S111), the switch unit 11 checks the header field of the transmission packet (S112). Specifically, in order to determine whether the header information coincides with the information in the white list table WL, the switch unit 11 acquires the transmission source address (src address), the transmission source port number (src port num), the destination address (dst address), and the destination port number (dst port num) from the header field of the packet.

Next, the switch unit 11 checks whether there is information in the WAN part of the white list table WL that coincides with the header information of the transmission packet (S113). Specifically, the switch unit 11 determines whether the transmission source address, the transmission source port number, the destination address, and the destination port number of the transmission packet coincide with the transmission source address, the transmission source port number, the destination address, and the destination port number on the WAN side of the white list table WL.

In the example shown in FIG. 7, when the header information of the transmission packet is the transmission source address X1.X2.X3.X4, the destination address Y1.Y2.Y3.Y4 and the destination port number 80 or 443, or the transmission source address X1.X2.X3.X4, the destination address Z1.Z2.Z3.Z4 and the destination port number 80 or 443, it is determined that the header information coincides with the information in the white list table WL. Otherwise, it is determined that the header information does not coincide with the information in the white list table WL.

When it is determined in S113 that there is information in the WAN part of the white list table WL that coincides with the header information of the transmission packet, the switch unit 11 checks whether the transmission packet has been transmitted by the process of the process id specified in the white list table WL (S114). That is, the switch unit 11 checks the flow information (session information) and the socket information in the OS and compares them, thereby determining whether the process id specified in the white list table WL (WAN) coincides with the process id of the process that has transmitted the transmission packet.

In the example shown in FIG. 7, when the transmission source address is X1.X2.X3.X4, the destination address is Y1.Y2.Y3.Y4, and the destination port number is 80 or 443, if the process id of the transmission packet is 1001, it is determined that the packet has been transmitted from the corresponding process. When the transmission source address is X1.X2.X3.X4, the destination address is Z1.Z2.Z3.Z4 and the destination port number is 80 or 443, if the process id of the transmission packet is 1002, it is determined that the packet has been transmitted from the corresponding process. Otherwise, it is determined that the packet has not been transmitted from the corresponding process.

For example, when the switch unit 11 receives the packet in which the rules have not been configured, the switch unit 11 sends an inquiry about the rules of the packet to the switch controller 13. When the switch controller 13 acquires the flow information (the header information of the IP packet=the transmission source address, the transmission source port number, the destination address, and the destination port number) from the switch unit 11, the switch controller 13 checks with which inode number (file identification information of Linux) the flow information coincides. In this case, the port to which the process is listening is checked by a netstat command of Linux, the port number is searched from “/proc/net/tcp(udp)” by a grep command, and the inode number is checked from the port number. Further, the process ID of the process that is performing the socket communication is checked from the inode number by an is command, and the application is checked from the process id by a ps command.

When it is determined in S114 that the packet has been transmitted from the corresponding process, the switch unit 11 forwards the transmission packet (S115). That is, the switch unit 11 forwards the packet to the destination that has been specified (des address, dst port num), as a result of which the switch unit 11 forwards the packet to the permitted server. In the example shown in FIG. 7, when the destination address is Y1.Y2.Y3.Y4, the switch unit 11 forwards the packet from the communication interface IF_2 to the server SR_1. When the destination address is Z1.Z2.Z3.Z4, the switch unit 11 forwards the packet from the communication interface IF_2 to the server SR_2.

When it is determined in S113 that there is no information in the WAN part of the white list table WL that coincides with the header information of the transmission packet or when it is determined in S114 that the packet has not been transmitted by the corresponding process, the switch unit 11 discards the transmission packet (S116).

While the communication control in the direction from the device to the gateway (application) and the direction from the gateway (application) to the server has been described in FIGS. 8 and 9, a similar control is performed also in the opposite direction, that is, the direction from the server to the gateway (application) and the direction from the gateway (application) to the device.

### Effects of this Embodiment

As described above, according to this embodiment, even when a plurality of systems (device-application-server) are used physically in one gateway, the communications of the respective systems can be logically separated from each other (closed), whereby it is possible to improve security.

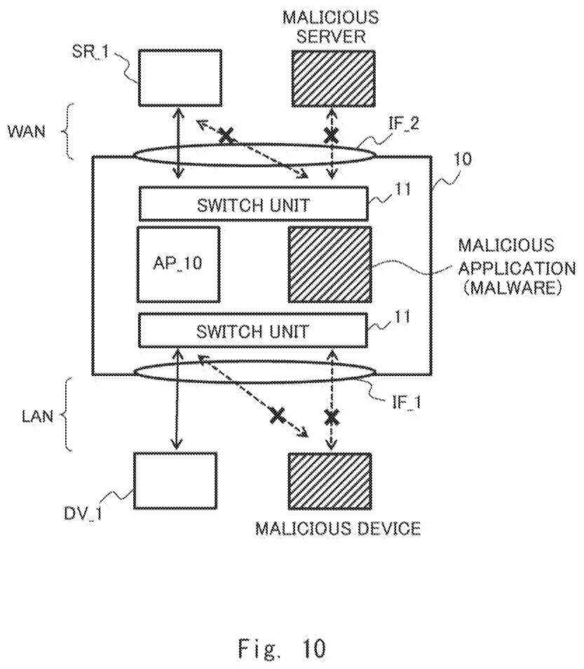

Due to the aforementioned control, only the communication of a combination of the device, the application mounted on the gateway, and the server that has been allowed by the user can be established, whereby it is possible to prevent security problems regarding communication such as a problem that information may be leaked out from unexpected malware and a problem that communication from an unauthorized device may reach the server. For example, as shown in FIG. 10, it is possible to prevent communication between a malicious device or a malicious server and the application of the gateway and communication between a malicious application on the gateway and a device or a server.

### Second Embodiment

Hereinafter, with reference to the drawings, a second embodiment will be explained.

The gateway according to the first embodiment will be further discussed. Two cases, that is, a case in which the packet from the device is sent to the server on the cloud via the application mounted on the gateway and a case in which the device sends the packet directly to the server without passing the application on the gateway (the gateway forwards the packet), can be considered.

In the latter case, the gateway rewrites the IP address and the port number of the packet that the gateway has received from the device and then forwards the resulting packet to the server. This processing is called Network Address and Port Translation (NAPT), which is the same as the processing that a typical broadband router executes.

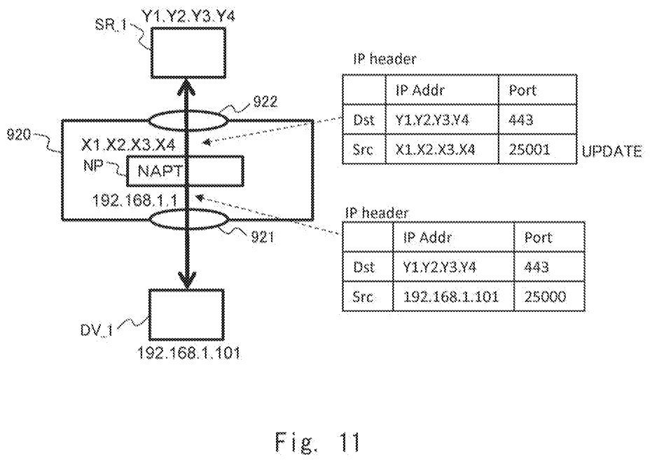

FIG. 11 shows an example in which the NAPT communication is performed in a gateway 920 according to the reference example. As shown in FIG. 11, the gateway 920 according to the reference example includes a NAPT processor NP that performs conversion processing by NAPT. The IP address 192.168.1.1 is allocated to a communication interface 921 and the IP address X1.X2.X3.X4 is allocated to a communication interface 921.

When the device DV_1 (IP address 192.168.1.101) sends a packet to the server SR_1 (IP address Y1.Y2.Y3.Y4), the device DV_1 first sends a packet in which the transmission source address 192.168.1.101, the transmission source port number 25000, the destination address Y1.Y2.Y3.Y4, and the destination port number 443 are configured in the header to the gateway 920.

When the NAPT processor NP of the gateway 920 receives the packet from the device DV_1, the NAPT processor NP converts the IP address and the port number of the header in order to forward the packet to the server SR_1. That is, the NAPT processor NP forwards the packet in which the transmission source address and the transmission source port number of the header have been respectively updated to X1.X2.X3.X4 and 25001 to the server SR_1.

Since the port number as well as the IP address is converted by NAPT processing, a plurality of equipment and devices may share one IP address. The NAPT processing is a function that is a standard function installed in the Linux kernel.

In this embodiment, even when both the communication that uses the application of the gateway and the communication of NAPT are performed in one gateway, they are logically separated from each other. While an example in which the NAPT is applied to the gateway will be explained in the following example, Network Address Translation (NAT) or address conversion similar to that may instead be applied.

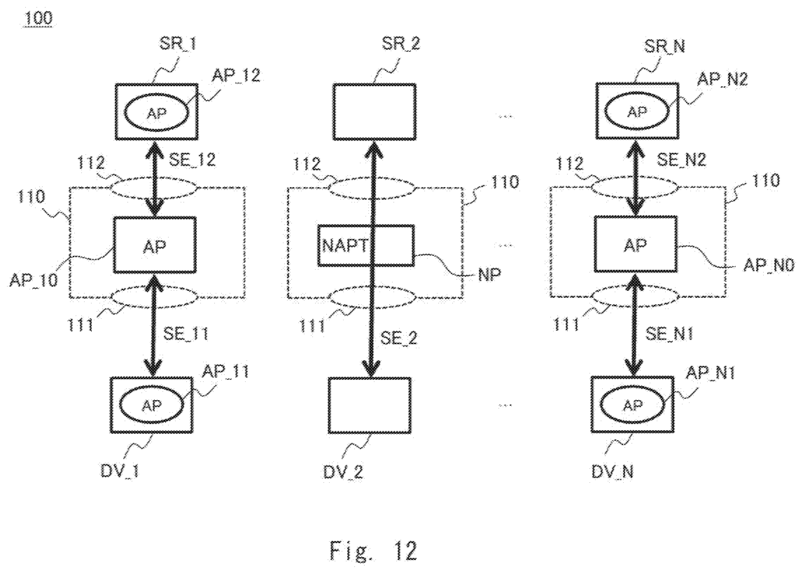

FIG. 12 shows an image in which the communication paths are logically separated from each other in the communication system according to this embodiment. As shown in FIG. 12, the application AP_10 (AP_N0 and the like as well) of the gateway 110 according to this embodiment is connected to the application AP_11 of the device DV_1 via the session SE_11 and is further connected to the application AP_12 of the server SR_1 via the session SE_12. The NAPT processor NP of the gateway 110 relays the session SE_2 connected between the device DV_2 and the server SR_2 by NAPT processing. Accordingly, the communication paths are logically separated from each other in the configuration in which both the NAPT communication and the communication that uses the application of the gateway are performed.

In order to handle these two types of communication in one gateway, a white list table similar to that in the first embodiment in which the communication between the device and the application mounted on the gateway and the communication between the application mounted on the gateway and the server (cloud) are associated with each other is used for control.

### <Specific Example of System>

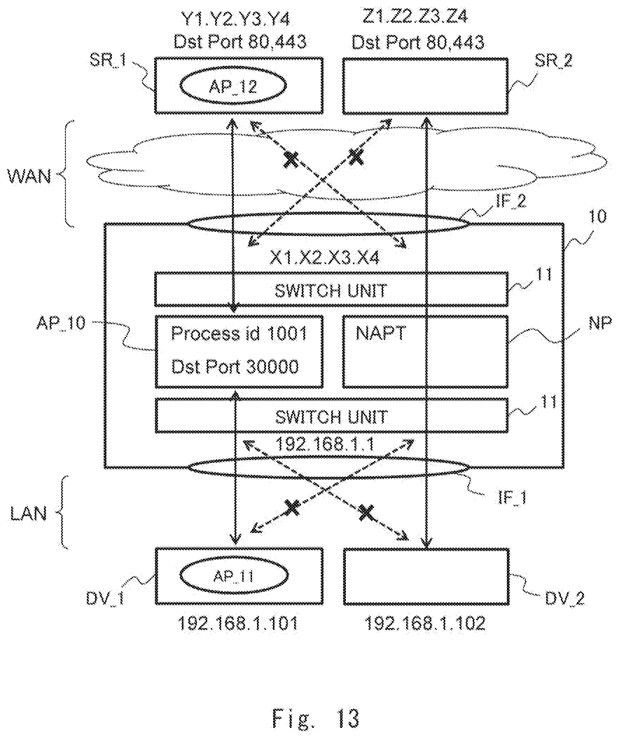

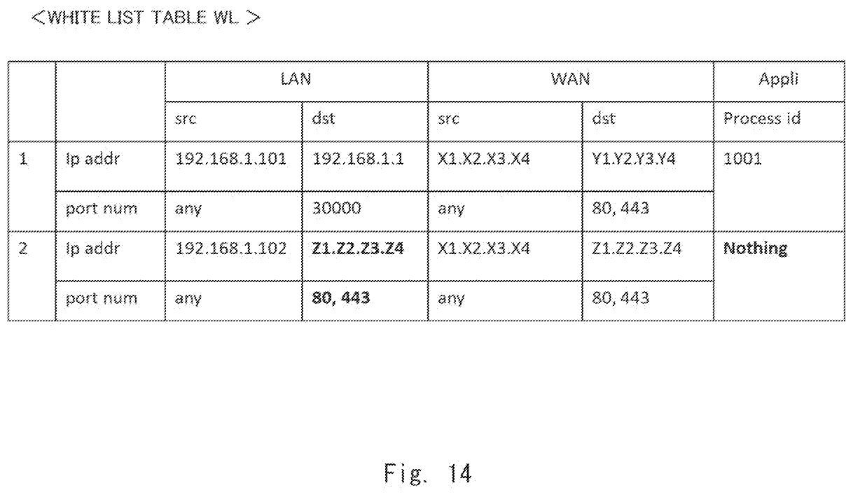

FIG. 13 shows a specific example of the system including the gateway according to this embodiment and FIG. 14 shows a specific example of the white list table used in this system. While two switch units 11 are respectively shown on the LAN side and on the WAN side and the NAPT processor NP is arranged therebetween in FIG. 13, the system may be formed of only one switch unit.

As shown in FIG. 13, the gateway 10 includes, besides the application AP_10 similar to FIG. 6 according to the first embodiment, a NAPT processor NP (or a relay processor such as a NAT processor). The application AP_10 connects a session with each of the device DV_1 and the server SR_1.

The NAPT processor NP relays the session between the device DV_2 and the server SR_2. When, for example, the packet is sent from the IP address 192.168.1.102 of the device DV_2 to the IP address Z1.Z2.Z3.Z4 and the port number 80 or 443 of the server SR_2, the NAPT processor NP performs NAPT processing (convert the transmission source address and the transmission source port number) and the packet is forwarded from the IP address Z1.X2.X3.X4 of the communication interface IF_2 to the server SR_2.

As shown in FIG. 14, similar to the first embodiment, the transmission source address, the transmission source port number, the destination address, and the destination port number on the LAN side, the transmission source address, the transmission source port number, the destination address, and the destination port number on the WAN side, and the process id of the application are associated with one another in the white list table WL. The white list table WL stores information to permit the packet between the LAN (device) and the application (the transmission source information and the destination information on the LAN side and the application identification information) and information to permit the packet between the application and the WAN (server) (the transmission source information and the destination information on the WAN side and the application identification information) and associates the transmission source information and the destination information on the LAN side with the transmission source information and the destination information on the WAN side as information to permit the packet between the LAN (device) and the WAN (server) by NAPT communication without the use of the application.

In this example, in accordance with the path shown in FIG. 13, the transmission source address 19.168.1.102, the transmission source port number any, the destination address Z1.Z2.Z3.Z4, and the destination port number 80 or 443 permitted on the LAN side for the NAPT communication, and the transmission source address X1.X2.X3.X4, the transmission source port number any, the destination address Z1.Z2.Z3.Z4, and the destination port number 80 or 443 permitted on the WAN side for the NAPT communication are associated with each other. In this case, since the application is not used, the process id of the application is not defined (Nothing).

### <Communication Control Between Device and Application Mounted on Gateway>

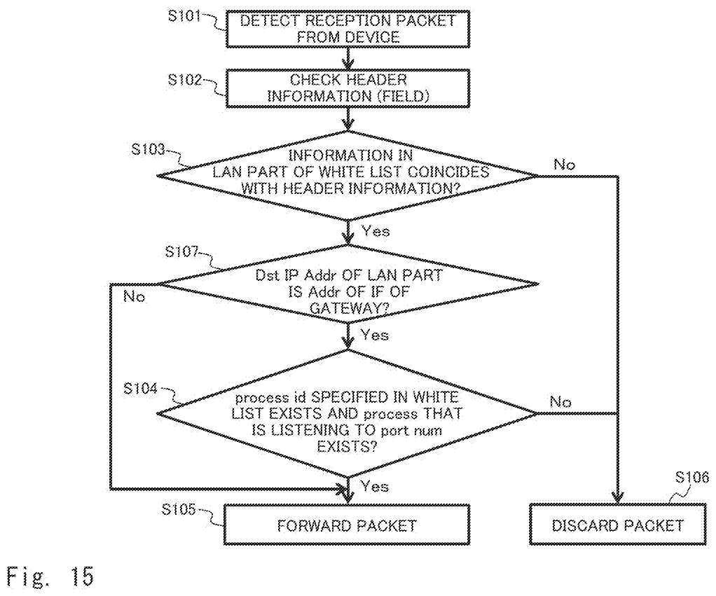

FIG. 15 is a control flow of the communication between the device and the application mounted on the gateway.

As shown in FIG. 15, similar to the first embodiment, when the switch unit 11 of the gateway 10 detects reception of the packet from the device DV (S101), the switch unit 11 checks the header field of the reception packet (S102) and checks whether there is information in the LAN part of the white list table WL that coincides with the header information of the reception packet (S103).

In the example shown in FIG. 14, when the header information of the reception packet is the transmission source address 192.168.1.101, the destination address 192.168.1.1, and the destination port number 30000, or the transmission source address 192.168.1.102, the destination address Z1.Z2.Z3.Z4, and the destination port number 80 or 443, it is determined that the header information coincides with the information in the white list table WL. Otherwise, it is determined that the header information does not coincide with the information in the white list table WL.

When it is determined in S103 that there is information in the LAN part of the white list table WL that coincides with the header information, the switch unit 11 checks whether the destination IP address of the LAN part of the white list table WL is an address of the communication interface IF_1 of the gateway 10 (S107). That is, the switch unit 11 checks whether the packet is the packet that the device has sent to the gateway or the packet is the packet that the device has sent to another apparatus (server etc.) In the example shown in FIG. 14, when the destination address is 192.168.1.1, it is determined that the packet is to be sent to the gateway. When the destination address is Z1.Z2.Z3.Z4, it is determined that the packet is not to be sent to the gateway.

When it is determined in S107 that the packet is not to be sent to the gateway, the packet is forwarded (S105). That is, the IP address and the port number are converted by the NAPT processor NP and the resulting packet is forwarded to the server SR. In the example shown in FIG. 14, for the transmission source address 192.168.1.102, the destination address Z1.Z2.Z3.Z4, and the destination port number 80 or 443, the transmission source address is converted into X1.X2.X3.X4, and the resulting packet is forwarded.

When it is determined in S107 that the packet is to be sent to the gateway, similar to the processing in the first embodiment, the switch unit 11 checks whether there is a process of the process id specified in the white list table WL and whether there is a process that is listening to the destination port number of the reception packet (S104). Then the switch unit 11 forwards the packet (S105) or discards the packet (S106).

### <Communication Control Between Application Mounted on Gateway and Server (Cloud)>

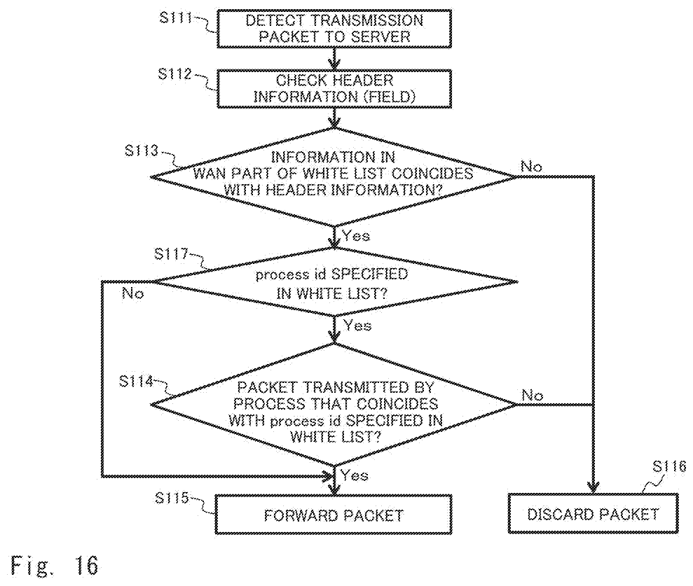

FIG. 16 is a control flow of the communication between the application mounted on the gateway and the server (cloud).

As shown in FIG. 16, similar to the first embodiment, when the switch unit 11 of the gateway 10 detects transmission of the packet from the application AP or the NAPT processor NP in the gateway (S111), the switch unit 11 checks the header field of the transmission packet (S112), and checks whether there is information in the WAN part of the white list table WL that coincides with the header information of the transmission packet (S113).

In the example shown in FIG. 14, when the header information of the transmission packet is the transmission source address X1.X2.X3.X4, the destination address Y1.Y2.Y3.Y4, and the destination port number 80 or 443, or the transmission source address X1.X2.X3.X4, the destination address Z1.Z2.Z3.Z4, and the destination port number 80 or 443, it is determined that the header information coincides with the information in the white list table WL. Otherwise, it is determined that the header information does not coincide with the information in the white list table WL.

When it is determined in S113 that there is information in the WAN part of the white list table WL that coincides with the header information of the transmission packet, the switch unit 11 checks whether the process ID is specified in the white list table WL (S117). That is, the switch unit 11 checks whether the packet has been sent from the application AP or the packet has been sent from the NAPT processor NP. In the example shown in FIG. 14, when the transmission source address is X1.X2.X3.X4, the destination address is Y1.Y2.Y3.Y4, and the destination port number is 80 or 443, it is determined that the packet has been sent from the application AP since the process ID (1001) is configured. When the transmission source address is X1.X2.X3.X4, the destination address is Z1.Z2.Z3.Z4, and the destination port number is 80 or 443, it is determined that the packet has been sent from the NAPT processor NP since the process ID is not configured.

When it is determined in S117 that the process ID is not specified, the packet is forwarded (S115). That is, the type of the communication is the NAPT communication. In this case, the packet is forwarded to the destination that has been specified (des address, dst port num). In the case shown in FIG. 14, the packet is forwarded to the destination address Z1.Z2.Z3.Z4 and the destination port number 80 or 443.

When the process ID is specified in S117, similar to the processing in the first embodiment, the switch unit 11 checks whether the transmission packet is the packet that the process of the process id specified in the white list table WL has transmitted (S114). Then the switch unit 11 forwards the packet (S115) and discards the packet (S116).

As described above, according to this embodiment, even in the configuration in which both the communication via the application as described in the first embodiment and the NAPT communication are performed, the paths can be logically separated from each other. Accordingly, it is possible to further improve the security.

The present disclosure is not limited to the aforementioned embodiments and may be changed as appropriate without departing from the spirit of the present disclosure.

The configurations in the aforementioned embodiments may be formed of hardware or software, or both of them. They may be formed of one hardware or software or may be formed of a plurality of hardware or software. Each function (each processing) in the embodiment may be achieved by a computer including a CPU, a memory and the like. For example, a relay (communication) program to perform the relay (communication) method in the embodiment is stored in the storage apparatus (storage medium) and each function may be achieved by executing the communication program stored in the storage apparatus by the CPU.

The programs can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present disclosure has been described above with reference to the embodiments, the present disclosure is not limited to them. Various changes that may be understood by one ordinary skilled in the art may be made to the configuration and the details of the present application within the scope of the present disclosure.

This application is based upon and claims the benefit of priority from Japanese Patent Application No. 2016-056895, filed on Mar. 22, 2016, the disclosure of which is incorporated herein in its entirety by reference.

### REFERENCE SIGNS LIST

10 GATEWAY
11 SWITCH UNIT
12 TCP/IP STACK PART
13 SWITCH CONTROLLER
14 MEMORY
15 POLICY INPUT/OUTPUT UNIT
100 COMMUNICATION SYSTEM
110 GATEWAY
111, 112 COMMUNICATION INTERFACE
113 APPLICATION EXECUTION UNIT
114 SWITCH UNIT
201, 202 COMMUNICATION APPARATUS
AP APPLICATION
DV DEVICE
IF COMMUNICATION INTERFACE
NP NAPT PROCESSOR
PT COMMUNICATION PATH
SE SESSION
SR SERVER
WL WHITE LIST TABLE

1. A relay apparatus comprising:
hardware, including a processor and a memory;
a first communication interface capable of communicating with a first communication apparatus;
a second communication interface capable of communicating with a second communication apparatus;
application execution unit implemented at least by the hardware and that executes a relay application, the relay application being connected to the first communication apparatus via a first communication path and connected to the second communication apparatus via a second communication path; and
switch unit implemented at least by the hardware and that associates the first communication apparatus with the relay application and associates the second communication apparatus with the relay application, thereby switches a packet to be input/output between the first and second communication interfaces and the relay application.

2. The relay apparatus according to claim 1, wherein the relay application executes edge computing processing regarding a function of the first or second communication apparatus.

3. The relay apparatus according to claim 1, wherein
the first communication path is terminated between the first communication apparatus and the relay application, and
the second communication path is terminated between the second communication apparatus and the relay application.

4. The relay apparatus according to claim 1, wherein the relay application comprises:
a first relay application that is connected to the first communication apparatus via the first communication path; and
a second relay application that is connected to the second communication apparatus via the second communication path.

5. The relay apparatus according to claim 4, wherein
the first communication path is terminated between the first communication apparatus and the first relay application, and
the second communication path is terminated between the second communication apparatus and the second relay application.

6. The relay apparatus according to claim 1, comprising table storage unit implemented at least by hardware and that stores a relay table that associates the first communication apparatus with the relay application and associates the second communication apparatus with the relay application,
wherein the switch unit switches the packet based on the relay table that has been stored.

7. The relay apparatus according to claim 6, wherein the relay table associates transmission source information and destination information included in the packet with identification information of the relay application.

8. The relay apparatus according to claim 7, wherein the switch unit forwards the packet to the relay application that corresponds to the destination information when the transmission source information and the destination information of the packet received from the first or second communication apparatus is included in the relay table.

9. The relay apparatus according to claim 8, wherein the switch unit forwards the packet to the relay application when a relay application of the identification information that corresponds to the transmission source information and the destination information in the relay table is executed to receive a packet of the destination information.

10. The relay apparatus according to claim 7, wherein, when the transmission source information and the destination information of the packet received from the relay application are included in the relay table, the switch unit forwards the packet to the first or second communication apparatus that corresponds to the destination information.

11. The relay apparatus according to claim 10, wherein the switch unit forwards the packet to the first or second communication apparatus when a relay application of the identification information that corresponds to the transmission source information and the destination information in the relay table has sent the packet.

12. The relay apparatus according to claim 6, comprising switch control unit implemented at least by the hardware and that configures processing rules of a packet received from the first and second communication apparatuses and the relay application in the switch unit based on the relay table.

13. The relay apparatus according to claim 12, wherein
the switch unit is an open flow switch that relays a flow between the first and second communication apparatuses and the relay application, and
the switch control unit is an open flow controller that controls the open flow switch.

14. The relay apparatus according to claim 1, comprising relay processing unit implemented by the hardware and that relays a third communication path connected between the first communication apparatus and the second communication apparatus.

15. The relay apparatus according to claim 14, wherein the relay processing unit is NAPT processing unit configured to convert an address and a port number of the packet or NAT processing unit configured to convert an address of the packet.

16. A communication system comprising a first communication apparatus, a second communication apparatus, and a relay apparatus connected between the first and second communication apparatuses, wherein the relay apparatus comprises:
hardware, including a processor and a memory;
a first communication interface capable of communicating with the first communication apparatus;
a second communication interface capable of communicating with the second communication apparatus;
application execution unit implemented at least by the hardware and that executes a relay application, the relay application being connected to the first communication apparatus via a first communication path and connected to the second communication apparatus via a second communication path; and
switch unit implemented at least by the hardware and that associates the first communication apparatus with the relay application and associates the second communication apparatus with the relay application, thereby switches a packet to be input/output between the first and second communication interfaces and the relay application.

17. A relay method in a relay apparatus comprising a first communication interface capable of communicating with a first communication apparatus and a second communication interface capable of communicating with a second communication apparatus, the method comprising:
executing a relay application, the relay application being connected to the first communication apparatus via a first communication path and connected to the second communication apparatus via a second communication path; and
associating the first communication apparatus with the relay application and associating the second communication apparatus with the relay application, thereby switching a packet to be input/output between the first and second communication interfaces and the relay application.

18. (canceled)
